(19) United States
(12) Patent Application Publication
(10) Pub. No.: US 2005/0108017 A1
(43) Pub. Date: May 19, 2005

(54) Determining language for word recognition event

(76) Inventors: John-Alexander Esser, Espoo (FI); Uwe Schwarz, Veikkola (FI)

Correspondence Address: PERMAN & GREEN, 425 POST ROAD, FAIRFIELD, CT, 06824, US

(21) Appl. No.: 10/948,816

(22) Filed: Sep. 23, 2004

(30) Foreign Application Priority Data
Oct. 27, 2003 (FI) 20031566

(51) Int. Cl. G10L 11/00

(52) U.S. Cl. 704/277

(57) ABSTRACT

The invention relates to a method for selecting language for word recognition in a data processing device, wherein at least two different languages are selectable for word recognition. The data processing device stores at least one predetermined rule specifying how language for word recognition is to be selected for a word recognition event. The method includes the step of selecting the language according to the predetermined rule prior to the word recognition.

### BACKGROUND OF THE INVENTION

The invention relates to determining language for a word recognition event in a data processing device.

Electronic devices such as laptop or desktop computers, PDA devices or mobile stations are widely used for text-based communications. Text is generally entered into the computer by means of a keyboard. Other text input devices include a touch-sensitive screen overlaid on top of a graphical image of a keyboard, a system which detects the motion of a pen in combination with handwriting recognition software, or a speech recognition system converting speech to text. The text is then sent to a particular software application running on the computer.

Because there are a limited number of words available in any given language, many of the words of the given language are used frequently. Recognizing that various patterns of words are repeated, computer systems have been developed which complete text, based on the already entered text. In word prediction systems, an input character may be analyzed, with respect to the prior history of text entered, to predict the text likely to follow the input character or substring of characters entered. For example, lists of the most recently used words are utilized in such text completion applications. This kind of list gives a menu of recently used names or files so that they can be quickly opened without retyping the name. There are also dictionary-based word prediction applications. In certain applications it is possible for the user to complement the dictionary by adding his or her own entries. One such text recognition application is the T9™ Text Input used in many mobile phones. In the widely used ITU-T 12 button keyboard there are more than one, typically three characters selectable by one button. The T9™ Text Input predicts the word such that the user needs to push a button only once regardless of which character associated with the button is needed to the word.

In dictionary-based word recognition systems the correct dictionary, i.e. the language has to be first selected. Users communicating in multiple languages using their wireless device have to manually change the dictionary language every time they want to input text in a different language.

A word processing application developed for desktop computers employs spell checking, which determines the language automatically. The language is determined by special language detection algorithms and statistics analyzing the letter combinations in every sentence. Thus, in order to work, it requires that text has been inputted. Also words that exist in many languages may cause erroneous language selection. Further, the algorithms and statistics required by this kind of language selection may require a lot of memory resources.

### BRIEF DESCRIPTION OF THE INVENTION

An object of the invention is thus to provide an enhanced language selection method for word recognition in data processing devices. The objects of the invention are achieved by methods, data processing device and a computer program product which are characterized by what is disclosed in the independent claims. Some preferred embodiments of the invention are disclosed in the dependent claims.

According to an aspect of the invention, the data processing device stores at least one predetermined rule specifying how language for word recognition is to be selected for a word recognition event. The language for a word recognition event is selected according to the predetermined rule prior to the word recognition. A rule refers generally to information determining at least a feature of a word recognition event according to which the language is to be selected. A word refers to a combination of any kind of characters.

An advantage of the arrangement of the invention is that the language may be selected automatically without any user intervention. The rules may be tailored such that the language can be pre-selected in different usage contexts where word recognition is needed. Thus the usability of wireless terminals in multi-lingual context can be considerably enhanced, for instance. Further, there is no need to have any inputted words. This makes it possible that word recognition algorithm can be applied with correct language already for the first words. The rule-based language selection arrangement can also be simple and does not require large processing resources.

According to one embodiment, the rules define at least one identifier associated with the word recognition event. When selecting language, at least one identifier associated with a word recognition event being initiated is checked. The language is selected according to the identifier. For instance, the identifier may determine the language to be used and be associated with information on at least one user, whereby the language can be selected according to the native language of the intended recipient of content to which the word recognition is applied. According to another embodiment, the identifier may further specify the word recognition event. For instance, the identifier may identify the application, whereby the language may be selected application-specifically. This enables the context of the word recognition event to be quickly determined by checking the identifier, and the language associated with this determined identifier can then be selected.

### BRIEF DESCRIPTION OF THE DRAWINGS

The invention is now described in closer detail in connection with some embodiments and with reference to the accompanying drawings, in which

FIG. 1 is a block diagram showing a data processing device supporting text recognition and language determination, and

FIG. 2 is a flow diagram showing a method according to an embodiment of the invention for determining the language for a word recognition event.

### DETAILED DESCRIPTION OF THE INVENTION

The invention can be applied to any data processing device that can be arranged to determine a language for a word recognition event in the device. One example of such word recognition is word prediction but the invention may be applied also to other kind of word recognition applications.

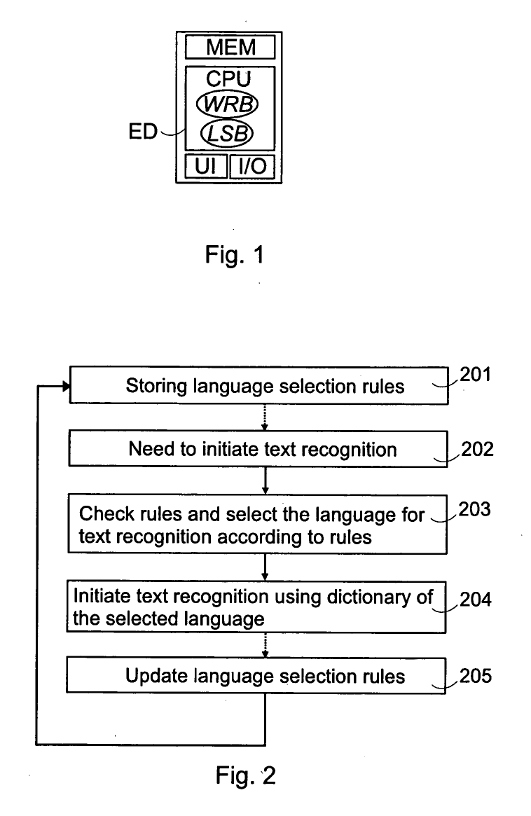

As illustrated in FIG. 1, a data processing device ED comprises memory MEM, a user interface UI, I/O means I/O for arranging data transmission, and a central processing unit CPU comprising one or more processors. The memory MEM comprises a read only memory portion and a rewritable portion, such as a random access memory and FLASH memory. The user interface UI typically comprises a screen and a keyboard via which words may be inputted to the data processing device. It is to be noted that also other kinds of input methods may be used, e.g. speech recognition. A word recognition block WRB providing word recognition e.g. for a message editor or a word processing application is preferably implemented by executing in the CPU a computer program code stored in the memory MEM. There are many different methods on how the word recognition may be arranged by the WRB and how the content, to which word recognition is applied, can be inputted to the ED. The ED is also configured to provide a language selector block LSB which may select the language for at least one application in the ED, preferably at least for a word recognition event by the WRB. The language selection block LSB may be an independent entity connected to at least one application or it may be implemented as part of another entity such as the WRB or some application in the ED. The computer program code executed in the central processing unit CPU causes the data processing device ED to carry out the inventive features, some embodiments of which are illustrated in FIG. 2 and in the further embodiments thereof. The computer programs can be received via a network and/or be stored in memory means, for instance on a disk, a CD-ROM disk or other external memory means, from where they can be loaded into the memory MEM. Integrated circuits can also be used.

The ED can be e.g. a personal computer PC or a personal digital assistant PDA device. According to an embodiment, the ED is a mobile station further comprising a mobile station functionality for arranging wireless data transmission with a mobile telephone network. The ED may support any mobile communication standard known to one skilled in the art, e.g. a second generation global system for mobile communication GSM standard, a personal digital cellular PDC standard or a third generation mobile communication standard, such as one based on 3GPP (Third Generation Partnership Project) specifications. The ED may also comprise a functionality for accessing a wireless local area network WLAN or a private network, such as a terrestrial trunked radio TETRA.

According to an embodiment, the language for word recognition is selected based on at least one predetermined rule such that at least one piece of property information concerning a word recognition event being initiated is checked. The language associated with the property information in the predetermined rule is then selected.

FIG. 2 shows a method according to an embodiment of the invention for determining a language for a word recognition event. Language selection rules determining how the language for word recognition is to be selected are stored 201 in the memory MEM of the data processing devices ED. They can be stored 201 e.g. during the manufacturing of the ED or in connection with storing an application in need of language selection. The rules may be determined in many ways as will be illustrated later. According to an embodiment, they associate different word recognition contexts with language identifiers thus determining which language should be used for a particular word recognition context. It is to be noted that the rules may not be a single collection of rules but they may be distributed within the applications utilizing word recognition, for instance. It is also feasible that the rules are modified later and/or added based on user's preferences as illustrated by step 205.

When a word recognition event is to be initiated 202 in the data processing device ED, its language selector block LSB checks at least one predetermined language selection rule stored in the memory MEM. Thus, at least one feature related to the word recognition event being initiated is determined and the language associated thereto in the rules is checked. This step can be entered e.g. when the word recognition block WRB is activated, when an application utilizing word recognition is activated, or when the forming of a new message is selected. Based, on the at least one rule, the language selector block LSB may automatically select 203 the language. Typically separate dictionaries are stored for different languages and thus the dictionary to be used is selected in step 203. Dictionary refers generally to any kind of grouping of words of a single language used for word recognition. After step 203, the word recognition may begin.

After the selection 203 of the language, the word recognition may be initiated 204 and already the first characters can be checked according to the correct (predefined) language. Any word recognition method suitable for data processing devices and input methods can be applied, one example being the T9™ Text Input method. Some other examples are iTAP, Letter-Wise, and eZiText. During the word recognition event, e.g. a message input event, the language typically remains unchanged. When a further word recognition event is to be initiated, the method can be repeated by entering again step 202.

According to an embodiment, the language selection rules may be updated 205. This update may be based on language selection history or other usage history. For instance, if the user frequently selects a language other than what is proposed by the rules for messages to a certain contact number, the rules can be updated such that this language is associated with the contact number.

According to an embodiment, the rules may be prioritized. Thus the language may be selected according to a higher priority rule if there are contradicting rules. The user may specify in step 205 or 201 the priority of the rules. For instance, the user may specify that the language is selected according to the language of the incoming message instead of the native language associated with the message sender.

According to a further embodiment alternative to step 203, the user of the data processing device ED is provided with the eventual selection of the language to be used for the word recognition event. This embodiment can be used, if no specific language can be defined for the word recognition event (e.g. there is no rule specified), if there are more than one language which may be used according to the rules, or if the user otherwise wishes to control the language selection. The user interface UI can be used for showing the alternative languages. The user can directly select one of the alternative languages for the word recognition event. The ED waits until the user has selected the language and the language selected by the user will then be the language used in the word recognition. The advantage of this embodiment is that errors can be avoided in the language selection when there is no explicit language based on the above described check.

In the following some embodiments of the language selection are described in more detail, these embodiments may be applied in step 203 of FIG. 2. According to an embodiment of the invention, the rules define at least one identifier associated with the word recognition event. This identifier may directly identify the language that is to be selected with the associated event or the identifier may specify the event; thus the rules may define two associated identifiers. At least one identifier associated with a word recognition event being initiated is checked. The language for the word recognition is selected according to the identifier.

According to an embodiment, the identifier is associated with information on at least one user. Further, the identifier may describe the language to be used. Thus the ED is arranged based on the rules to check the language identifier associated with a user as there is a need to address information on which word recognition will be employed to the user. The language determined by the identifier is selected for the word recognition of the information addressed to the user. For instance, a recipient is first selected for a message to be written, and the language for the word recognition, utilized during message editing, is then selected based on the language identifier associated with the user information. The language identifier may be specified in the user information in many ways, for instance as one field in a file including user information. This embodiment may be utilized for word recognition of any messaging application, such as MMS (Multimedia Messaging Service), SMS (Short Message Service), EMS (Enhanced Messaging Service), email or chat applications.

According to an embodiment, at least a part of an addressing identifier such as an internet address, a phone number, or a universal resource identifier (e.g. a universal resource locator, URL) is associated with at least one language in the rules. In this embodiment, the ED is arranged, in response to a need to address information for which the word recognition is employed to the addressing identifier, to check, on the basis of the rules, the (at least part of the) addressing identifier relating to this word recognition event to be initiated. The language associated with the (at least part of the) addressing identifier is then selected. As in the previous embodiment, the rules may comprise language identifiers associated with the addressing identifiers or parts thereof. For instance, the rules may define that when a message is to be sent to a domain name whose last part is se, Swedish is automatically selected as the language for the word recognition of said message. According to another example, the country code of the recipient's phone number is checked, and the language is selected according to the language associated with the country code in the rules.

According to another embodiment, an application is associated with at least one language in the rules. As there is a need to employ word recognition for an application, the language associated with the application is checked, and the language associated with the application is selected. This embodiment may be implemented by associating an identifier of the application with at least one language to be used, whereby the ED is arranged on the basis of the rules first to check the identifier of the application and then to find out from the rules which language is specified for the application identifier. Another implementation example is to store one or more language identifiers in the application data, whereby the ED is arranged on the basis of the rules to check the data item specifying the language in each application's data and to select this language. One example of utilizing this embodiment is that the language selection rules determine that English is automatically selected when word recognition is applied for calendar entries. In addition or instead of this embodiment, it is also feasible that the rules are application-specific.

According to a further embodiment, the language is determined from any kind of received document. For instance, an earlier received and stored message which is to be replied, will determine the language for the word recognition. The data processing device ED is thus arranged (on the basis of the rules) to check always first e.g. on the basis of the received commands from the user, whether a new message is a reply to an earlier message. According to the rules, after it is detected that a new message is a reply message to an earlier message, the language used in the content of the earlier message is determined and the same language may then be automatically selected in the word recognition applied to the new message. The language may be determined from the information content of the document or the metadata of the document. For instance, the language may be determined by using any language determination algorithm which determines the language from the text of the message. One example of such language detection method is described in published patent application EP 1246075.

The message may comprise a language identifier determining the language of the message content. Thus the rules may define this identifier to be checked, whereby the electronic device ED (language selection block LSB) is configured to check the language identifier from the message and adjust the language of the word recognition of the new message to be the same as in the previous message. Another example of the language selection based on the metadata is to select the language according to the WAP page specific language preference. According to another embodiment, the language associated with the sender of the earlier received message may be selected. Thus information about the sender of the earlier message is checked from the earlier message and the language is selected according to one or more rules associated with this information. In this embodiment the above described features related to rules defining user specific and/or addressing identifier specific language selections may be applied.

According to one further embodiment, the rules define that the usage context of the electronic device ED determines the language for word recognition. For instance, the local language can be preferred when roaming abroad. The language could be determined based on the identifier of the local network operator. Another example is to utilize location information of the electronic device ED when selecting the language. For instance, location information from the GPS (Global Positioning System) system could be used.

The above illustrated embodiments may be utilized in any application wherein a language needs to be selected for word recognition. A typical application in which the language determination of the invention can be utilized is a text editor for inputting textual content to messages. Some other applications for which word recognition may be applied are the input of calendar entries, phone book entries, to-do-list entries and file naming. The present language selection method may also be used in connection with various spelling-check applications, for which the text may be provided by any input method, e.g. by speech recognition. It is feasible that the word recognition is performed by some other device than the device receiving input from the user. Thus the language may be selected according to one or more predetermined rules by the device receiving input or the device actually performing word recognition. In the latter case the language can be selected according to some indication or an identifier from the device receiving input. One example of such indication is the WAP page language preference. In one example the language for word recognition for entering text into WWW pages is selected by a WWW browser or a WWW server to be used.

It is obvious to one skilled in the art that as technology advances, the basic idea of the invention can be implemented in many different ways. Thus also other kinds of rules in addition to those already described may be developed to determine the language prior to word recognition. Also, the above described embodiments and the features thereof may be combined, removed or modified. The invention and its embodiments are thus not restricted to the examples described above but can vary within the scope of the claims.

1. A method for selecting language for word recognition in a data processing device, wherein the data processing device stores at least one predetermined rule specifying how language for word recognition is to be selected for a word recognition event, the method comprising the steps of:
checking an identifier of at least one recipient in response to a need to address information, for which the word recognition is employed, to the recipient, and
selecting, in accordance with at least one predetermined rule, the language associated with at least part of the recipient identifier prior to the word recognition.

2. A method as claimed in claim 1, wherein at least a part of an addressing identifier such as an Internet address, a phone number, or a universal resource identifier is associated with at least one language in the rules, and
the language associated with the at least part of the addressing identifier is selected in response to a need to address information for which the word recognition is employed to the addressing identifier.

3. A method for selecting language for word recognition in a data processing device, wherein the data processing device stores at least one predetermined rule specifying how language for word recognition is to be selected for a word recognition event, the method comprising the steps of:
checking a language associated with an application in at least one predetermined rule in response to a need to employ word recognition for the application, and
selecting the language associated with the application for the word recognition prior to the word recognition.

4. A method as claimed in claim 3, wherein the rules are application specific and determine the language to be used.

5. A method for selecting language for word recognition in a data processing device, wherein the data processing device stores at least one predetermined rule specifying how language for word recognition is to be selected for a word recognition event, the method comprising the steps of:
checking whether a new message is a reply to an earlier message,
checking the language associated with the earlier message or used in at least part of the content of the earlier message if the new message is a reply to the earlier message, and
selecting, in accordance with at least one predetermined rule, the language for the word recognition to be applied for the new message on the basis of the check.

6. A data processing device comprising:
a word recognition block,
memory for storing at least one predetermined rule specifying how language for word recognition is to be selected for a word recognition event,
means for checking an identifier of at least one recipient in response to a need to address information, for which the word recognition is employed, to the recipient, and
means for selecting, in accordance with at least one predetermined rule, the language associated with at least part of the recipient identifier prior to the word recognition.

7. A data processing device as claimed in claim 6, wherein at least a part of an addressing identifier such as an Internet address, a phone number, or a universal resource identifier is associated with at least one language in the rules, and
the data processing device is configured to select the language associated with the at least part of the addressing identifier in response to a need to address information for which the word recognition is employed to the addressing identifier.

8. A data processing device as claimed in claim 6, wherein the data processing device is a wireless device and the device is configured to select the language for word prediction.

9. A data processing device comprising:
a word recognition block,
memory for storing at least one predetermined rule specifying how language for word recognition is to be selected for a word recognition event,
means for checking a language associated with an application in at least one predetermined rule in response to a need to employ word recognition for the application, and
means for selecting the language associated with the application for the word recognition prior to the word recognition.

10. A data processing device as claimed in claim 9, wherein the rules determine the language to be used, and
the data processing device is configured to check a data item specifying the language in the application's data and to select this language.

11. A data processing device as claimed in claim 9, wherein the data processing device is configured to check on the basis of the rules the identifier of the application, and
the data processing device is configured to define on the basis of the rules the language associated with the application identifier.

12. A data processing device as claimed in claim 9, wherein the data processing device is a wireless device and the device is configured to select the language for word prediction..

13. A data processing device comprising:
a word recognition block,
memory for storing at least one predetermined rule specifying how language for word recognition is to be selected for a word recognition event,
means for checking whether a new message is a reply to an earlier message,
means for checking the language associated with the earlier message or used in at least part of the content of the earlier message if the new message is a reply to the earlier message, and
means for selecting, in accordance with at least one predetermined rule, the language for the word recognition to be applied for the new message on the basis of the check.

14. A data processing device as claimed in claim 13, wherein the data processing device is configured to check the language from the information content of the earlier message.

15. A data processing device as claimed in claim 13, wherein the data processing device is configured to check the language from the metadata of the earlier message.

16. A data processing device as claimed in claim 13, wherein the data processing device is a wireless device and the device is configured to select the language for word prediction.

17. A computer program product for controlling a data processing device comprising a word recognition block, wherein said computer program product comprises:
program code causing the data processing device to store at least one predetermined rule specifying how language for word recognition is to be selected for a word recognition event,
program code causing the data processing device to check an identifier of at least one recipient in response to a need to address information, for which the word recognition is employed, to the recipient, and
program code causing the data processing device to select, in accordance with at least one predetermined rule, the language associated with at least part of the recipient identifier prior to the word recognition.

18. A computer program product for controlling a data processing device comprising a word recognition block, wherein said computer program product comprises:
program code causing the data processing device to store at least one predetermined rule specifying how language for word recognition is to be selected for a word recognition event,
program code causing the data processing device to check a language associated with an application in at least one predetermined rule in response to a need to employ word recognition for the application, and
program code causing the data processing device to select the language associated with the application for the word recognition prior to the word recognition.

19. A computer program product for controlling a data processing device comprising a word recognition block, wherein said computer program product comprises:
program code causing the data processing device to store at least one predetermined rule specifying how language for word recognition is to be selected for a word recognition event,
program code causing the data processing device to check whether a new message is a reply to an earlier message,
program code causing the data processing device to check the language associated with the earlier message or used in at least part of the content of the earlier message if the new message is a reply to the earlier message, and
program code causing the data processing device to select, in accordance with at least one predetermined rule, the language for the word recognition to be applied for the new message on the basis of the check.
